(19) United States
(12) Patent Application Publication
(10) Pub. No.: US 2009/0079386 A1
(43) Pub. Date: Mar. 26, 2009

(54) ELECTRICAL RECHARGER UNIT

(75) Inventors: George Gallagher, Wales (GB); Mark Dodgson, Wales (GB); Kenneth Hall, Swindon (GB)

Correspondence Address: CHARLES N. QUINN;FOX ROTHSCHILD LLP, 2000 MARKET STREET, 10TH FLOOR, PHILADELPHIA, PA, 19103, US

(73) Assignee: Zi Medical PLC, St. Asaph (GB)

(21) Appl. No.: 11/664,751

(22) PCT Filed: Sep. 30, 2005
(86) PCT No.: PCT/GB2005/003782

§ 371 Date: Jun. 18, 2008

(30) Foreign Application Priority Data
Oct. 6, 2004 (GB) 0422349.1

(51) Int. Cl. H02J 7/00

(52) U.S. Cl. 320/108

(57) ABSTRACT

An electrical recharger unit (10) comprising a master (12) and slave (14) device each having electromagnetic coils capable of being brought into close or touching proximity to one another. A power supply delivers electrical currents to an electromagnetic coil of the master device. The electromagnetic coils are wound onto a transformer core and primary transfer means made at least partially of a ferromagnetic polymer material is associated with an end of each core to provide enhanced contact between the master and slave device.

The present invention relates to an electrical recharger unit, and in particular to an improved inductive electrical recharger unit.

Inductive electrical recharger units are used where it is desired to transfer electrical current from a “master” or “charger” device to a “slave” device without having to make a physical electrical connection between the two. Inductive recharger units are used extensively in applications where either the charger of slave device must be hermetically sealed, i.e. where providing a conventional power jack would break the seal. Examples of where inductive recharger units are widely used include domestic devices such as electric toothbrushes and razors, whose circuitry must be protected from water ingress, but which require regular recharging.

Inductive electrical recharger units are well known, but suffer from a number of problems—the main problem being a lack of efficiency. An inductive charger unit generally comprises an electromagnetic coil disposed within the master or charger unit that is arranged to interact with a corresponding electromagnetic coil associated with a slave device. By passing an alternating current through the coil of the charger unit, an alternating magnetic field is generated in the vicinity thereof. The generated magnetic field causes electrons in the coil of the slave device to oscillate, thereby causing an electric current to flow in the slave coil.

The efficiency of the interaction, i.e. the ratio of current in the charger coil to that in the slave coil is quite low, typically just a few percent. The efficiency of the interaction can be improved, to up to ˜10%, by the provision of ferrite cores, which channel the lines of magnetic flux more effectively. Further means of improving efficiency include; bringing the charger and slave coils into very close proximity; ensuring that they are correctly aligned; and providing a channelling medium between the respective coils, such a ferrite-containing gel.

Due to the low efficiency of known inductive charger units, they generally only find applications in “low power, high charge time” devices. For example, an electric toothbrush uses a minimal amount power (i.e. milliwatts) for around 5 minutes a day, but is docked into its charger to recharge for the remaining 1435 minutes of the day. However, in “high power, short charge time” applications, inductive recharger units are generally regarded as unsuitable.

Of course, it is possible to increase the current in the charger coils to transfer more power into the slave device to achieve the necessary charge time to power transfer ratio, but with 90% of the supplied power being dissipated as heat (e.g. in eddy currents and resistive losses), either or both of the charger and slave devices are susceptible to overheating. This is particularly problematic where the slave unit comprises a battery, which is likely to leak or explode under such conditions.

One possible application where a high power, short charge time regime is required in conjunction with the advantages of inductive recharger units is in a syringe driver system. A syringe driver system comprises a drive unit adapted to deliver a desired quantity of a drug, at a desired rate from a syringe, into a patient. The drug delivery time can be quite long, e.g. a dose delivered throughout the course of a day, leaving little time for recharging. Moreover, being a medical device, the syringe driver must be cleanable using water, detergents, solvents and/or an autoclave. Providing the syringe driver with a conventional charging jack is therefore highly undesirable, as ingress of fluids into the circuitry of the driver could cause it to malfunction, with potentially catastrophic consequences i.e. drug overdose or underdose.

The present invention aims to provide an improved inductive recharger unit. It is also an object of the present invention to try to address one or more of the above problems.

Accordingly, a first aspect of the invention provides an inductive recharger unit comprising a master device adapted to transfer electrical power to a slave device comprising;

electromagnetic coils associated with the master and slave devices capable of being brought into close or touching proximity of one another;

a power supply for delivering electrical currents to the electromagnetic coil of the master device; wherein

the electromagnetic coils are each wound onto a transformer core, each core comprising a shaft about which the coil is wrapped and a primary transfer means associated with an end of the core, the primary transfer means being at least partially manufactured of a ferromagnetic material.

The transformer core may be a conventional laminated transformer core or, more preferably is a ferromagnetic core. The core and primary transfer means are preferably integrally formed. The primary transfer means may be any appropriate shape to match the shape of the primary transfer means of the other device, such as a block, E-line or T-line transformer (square or oblong section) or split torroidal (round or oval section). Preferably, the primary transfer means is a disc of ferromagnetic or ferromagnetic-containing material.

A secondary transfer means may also be provided. A preferred secondary transfer means comprises a tube of ferromagnetic material arranged to at least partially surround each electromagnetic coil. The purpose of the secondary transfer means is to provide an improved return path for magnetic flux. The secondary transfer means may be manufactured of the same materials as the primary transfer means. The secondary transfer means need not be formed of a complete tube, i.e. it may comprise partial tube sections or strips of ferromagnetic material arranged circumjacent to the electromagnetic core.

The electromagnetic coils of the invention may be of any suitable type. It is envisaged, however, that the electromagnetic coils will comprise an electrically conductive wire (e.g. copper wire) wrapped around a ferromagnetic core (e.g. ferrite).

More preferably still, the primary transfer means comprises a disc of ferromagnetic polymer material. This material is electrically non-conductive but highly permeable to magnetic flux. This feature means that the slave device does not have any electrical connections on the exterior thereof, thereby minimising the risk of electrical shock and/or electrical emissions/discharges. It also minimises the risk of electromagnetic interferences caused by external devices. Furthermore, this feature assists in providing good contact between the charge and the slave device, thereby increasing the efficiency of energy transfer. Any plastic and ferrite material may be used for the ferromagnetic polymer material, for example, a polymer-ferrite composite material, e.g. a ferrite powder—polyethylene admixture may be used. Where a polymer-ferrite composite material is used, it is preferably formed by injection moulding. Alternatively, it may be stamped from a sheet of material.

The primary and/or secondary transfer means of the master and/or slave device may be provided with a cover, for example, in the form of a cap for preventing the ingress of dirt. It is to be appreciated that the cap should be made of a material that allows for an efficient flux transfer loop to be created between the master and slave devices. Preferably, a polycarbonate cap is provided over the primary and/or secondary transfer means.

The inductive recharger unit of the invention may be adapted for use with a high power drain, low charge time device. There are, of course, many other devices that could benefit from the advantages of the present invention. It may, for example, be desirable to use the present invention in conjunction with a low power, high charge time device to minimise energy wastage.

In one possible embodiment of the invention, the inductive recharger unit may be a charger unit for a syringe driver unit.

Preferably, the electrical charger unit includes alignment means capable of ascertaining when the electromagnetic coils are in close or touching proximity and when they are aligned with one another. To this end a second aspect of the invention provides an inductive recharger unit comprising master device adapted to transfer electrical power to a slave device comprising;

electromagnetic coils associated with the master and slave devices capable of being brought into close or touching proximity of one another;

a power supply for delivering electrical currents to the electromagnetic coil of the master device;

an alignment means for ascertaining when the electromagnetic coils are in close or touching proximity of and aligned with one other; and

a control means for controlling the power supply;

wherein the control means is adapted to switch the power supply on only when the electromagnetic coils are within predetermined proximity and alignment parameters.

A third aspect provides a method of transferring electrical power from a master device to a slave device, the method comprising the steps of:

bringing electromagnetic coils associated with the master and slave devices into close or touching proximity of one another;

ascertaining when the electromagnetic coils are in close or touching proximity with and aligned with one other; and

switching on a power supply for delivering electrical currents to the electromagnetic coil of the master device only when the electromagnetic coils are within predetermined proximity and alignment parameters.

The power supply may be of any suitable type. It is envisaged, however, that the power supply will comprise a transformer for stepping-down mains voltage to a desired operating voltage. The power supply may additionally comprise phase-shift, rectifying, smoothing and/or other circuitry, whose functions are known to those of skill in the art.

The alignment means may comprise a sensor and an indicator, the sensor being capable of sensing when the indicator is in a desired location relative thereto. Preferably, the alignment means comprises a light source as an indicator and a light detector as sensor. The light source is preferably directional, e.g. shielded or focussed, such that the sensor must be aligned therewith to sense the emitted light.

In one possible embodiment of the invention, the light source is a shielded light emitting diode and the sensor is a light dependent resistor. Preferably, the light source is a focussed infrared light source and the sensor is an infrared detector.

The control means controls the power supply. The control means preferably comprises a circuit that detects the “state” of the sensing means. For example, the control means may comprise a circuit that interrogates the sensor to determine whether the light source is in correct alignment therewith. The sensor may give a light intensity reading that is proportional to the intensity of sensed light. The intensity of light sensed is preferably a function of the degree of alignment and/or the proximity of the light source to the sensor. If the light source and sensor are correctly aligned, i.e. within predetermined parameters, the circuit may then trip a relay to allow power to be delivered to the electromagnetic coil of the master device.

The charger control may be run using an open or a closed loop mode. With the open loop there is no proportional feedback from the battery charge circuit. In this mode the circuitry just goes flat out a maximum charge current whenever the presence of the slave unit is detected. Alternatively, the unit may be used in closed loop mode which will generate a non-contact feedback route from the slave to the charger. This feedback may then adjust the rate of the charging to allow it to be reduced when the battery is fully charged. The optical sensor may be used as a feedback mechanism for the control of the switching modulation of the primary of the transformer. There are several methods for doing this, such as a straight pulse width modulated signal may be sent over the optical pair, or a coded data word may be sent from the unit to the charger telling the charger to reduce the rate of charge.

The master device preferably comprises a cradle for retaining the slave device in a desired position. The cradle, where provided, is preferably be configured to self-align the slave device relative thereto, e.g. by the provision of tapered surfaces, engagement lugs and the like.

The sensing means may have communication means associated therewith. In a possible embodiment of the invention, the slave device has a circuit for determining a desired parameter, e.g. the battery charge status. The slave device may be adapted to make changes to the indicator in response to the value of the desired parameter, e.g. switching a light source from continuous to flashing mode when the battery is fully charged. The control means of the master device may be programmed to detect that change and to switch off the power supply accordingly. Of course, two-way communication may be possible by providing both the master and slave device with sensing means and indicating means. Such a device may enable the master device to determine the nature or type of slave device present, e.g. a “pain killer drug” syringe driver as opposed to a “blood-thinning drug” syringe driver.

Conveniently, the invention provides charging means and one or two-way communication means without making a physical electrical connection between the master and slave devices. The alignment sensing means and communication means can be integrated to reduce the complexity of the device.

A preferred embodiment of the invention shall now be described, by way of example only, with reference to the accompanying drawings, in which;

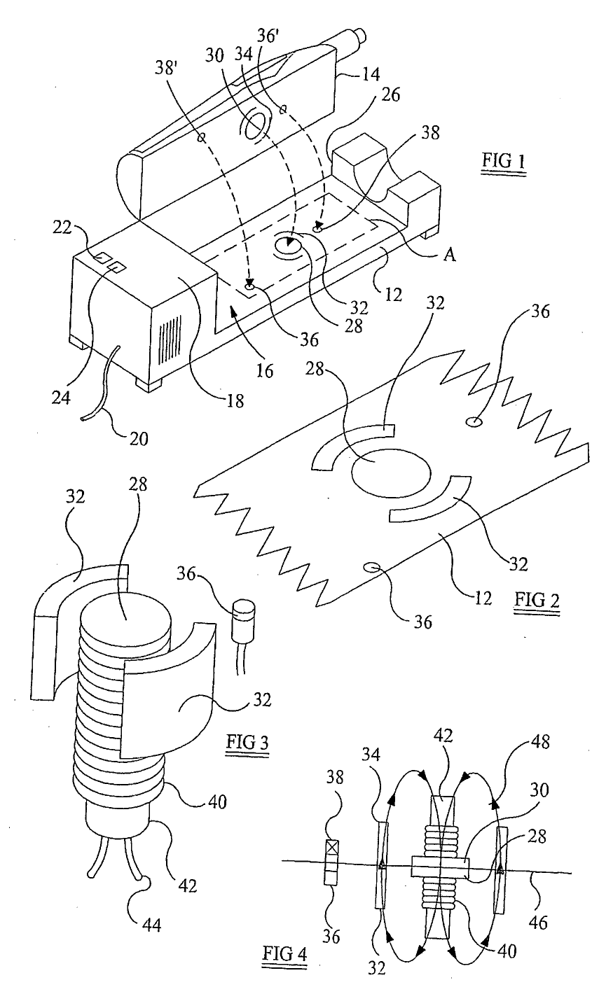

FIG. 1 shows a perspective view of the invention;

FIG. 2 shows a close-up view of area A of FIG. 1;

FIG. 3 shows a close-up view of area A of FIG. 1 with the casing removed;

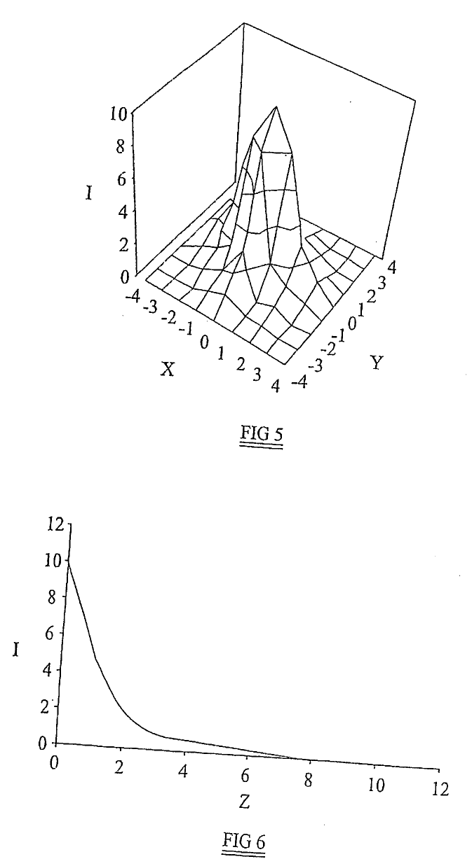

FIG. 4 illustrates the lines of magnetic flux between the primary and secondary transfer means of the master and slave devices;

FIG. 5 shows a schematic graph of intensity versus position in a lateral plane; and

FIG. 6 shows a schematic graph of intensity versus position along a vertical line.

Referring now to FIGS. 1 and 2, an electrical recharger unit 10 according to the invention is shown comprising master 12 and slave 14 devices. The master device 12 is a docking station, which comprises a charging cradle 16 and a transformer unit 18 connected to a mains supply 20. The transformer 18 has indicator lights 22 and 24 for indicating 22 when power is being supplied to the master unit 12 and for indicating 24 when the battery of the slave device 14 is fully charged, respectively.

The cradle 16 comprises a cut out 26, which only allows insertion of the slave device 14 in one orientation. In the illustrated embodiment, the slave device comprises a syringe driver unit.

Visible on the upper surface of the cradle 16 and the underside of the syringe driver 14 are primary transfer means 28 & 30, secondary transfer means 32 & 34, indicating means 36, 36′ and sensing means 38, 38′. The primary transfer means 28 & 30 comprise injection moulded ferrite-filled polymer discs that are hermetically sealed to the casings of the cradle 12 and syringe driver 14, respectively. The secondary transfer means 32 & 34 are formed in the same manner from partial tube sections of a similar material.

It is to be appreciated that a cap or cover (not shown) may be provided over the polymer discs of one or both of the master and slave devices to prevent ingress of dirt. Preferably, the cover is made of polycarbonate and only included on the slave device.

FIG. 3 shows a close-up of FIG. 2 with the casing removed. An electromagnetic coil 40 is wrapped around a ferrite core 42. An electrical current is delivered to the coil 40 via connector wires 44. The primary transfer means 28 is affixed to or formed integrally with an end of the ferrite core 42. Secondary transfer means 32 are formed of partial tube sections of ferrite-filled polymer. Indicating means 36, comprising an infrared transmitter, is disposed radially about the core 42.

As can be deduced from FIGS. 1 to 3, if the primary transfer means 28 & 30 are not correctly aligned with one another, then the sensing 38, 38′ and indicating means 36, 36′ will, likewise, not align, thereby attenuating or cutting-off the signal sensed by the sensing means. Misalignment may be lateral, vertical or rotational. Providing a pair of sensing 38, 38′ and indicating means 36, 36′ prevents the indicating means 36′ of the syringe driver 14 from being aligned with the sensing means 38′ of the cradle, but with the primary transfer means 28 & 30 being misaligned. Such a situation may occur with rotational misalignment.

FIG. 4 illustrates the magnetic flux that is set up when the primary and secondary transfer means of the master and slave device are aligned. As can be seen, the centreline 46 of the ferrite cores 42 are aligned, as are the sensing 36 and indicating means 38. The lines of magnetic flux 48 are channeled through the cores 42, via the primary transfer means 28 & 30 and on their return path, via the secondary transfer means 32 & 34. By providing good axial alignment of the coils 40 and primary 28 & 30 and secondary 32 & 34 transfer means, an efficient flux transfer loop is thereby created. With greater efficiency comes, not only the possibility of a greater power transfer ratio, but also the possibility of increasing the driving current as there will be less resistive and eddy current heating effects. However, if the coils 40 become misaligned, and the efficiency decreases, the sensor 38 will detect this. The change will be read by the control means and the input power reduced or cut off accordingly.

In the depicted embodiment, the syringe driver 14 also has a control means and various sensors for sensing the operation of the driver 14, the battery status etc. The indicating means 36 comprises an infrared transmitter that transmits an analogue or digital signal, relaying information about the syringe driver 14 to the sensing means 38 of the charger unit 12.

Finally, FIGS. 5 and 6 show schematic plots of light intensity I, sensed by the sensing means 38 as a function of the position of the syringe driver 14 relative to the charging unit 12. FIG. 5 shows how the detected light intensity I drops off as the syringe driver 14 is moved away from an ideal position (indicated with Cartesian coordinates 0,0) in the X and Y directions. FIG. 6 shows how the detected light intensity I drops off as the syringe driver 14 is moved vertically away from the cradle 12 in the Z direction. Accordingly, the intensity I of the signal is maximised when the syringe driver 14 is in position 0,0,0 with respect to the cradle. Any X, Y or Z deviation from that “ideal” position will result in a reduced detected intensity I, which relates to the transfer efficiency of the recharger unit 10.

Predetermined operating parameters may be selected to accord with safety and/or efficiency requirements. Thus, if the relative position deviates by more than 1 in any of the X, Y or Z directions, the power could be reduced, but if it deviates by more than 3, for example, the power is cut off. Further indicators or alarms may be provided on the recharger unit 10 to indicate if the relative position is outside the pre-determined operating parameters.

Transfer efficiencies of up to 70%, compared to 10% for known systems, have been achieved using the apparatus and method of the present invention.

1. An inductive recharger unit comprising a master device adapted to transfer electrical power to a slave device comprising;
electromagnetic coils associated with the master and slave devices capable of being brought into close or touching proximity of one another;
a power supply for delivering electrical currents to the electromagnetic coil of the master device; wherein
the electromagnetic coils are each wound onto a transformer core, each core comprising a shaft about which the coil is wrapped and a primary transfer means associated with an end of the core, the primary transfer means being at least partially manufactured of a ferrite powder-polyethylene mixture.

2. An inductive recharger unit as claimed in claim 1 wherein the transformer core is a laminated transformer core.

3. An inductive recharger unit as claimed in claim 1 wherein the transformer core is a ferromagnetic core.

4. An inductive recharger unit as claimed in claim 1 wherein the core and primary transfer means are integrally formed.

5. An inductive recharger unit as claimed in claim 1 wherein the shape of the primary transfer means is appropriate to match the shape of the other device.

6. An inductive recharger unit as claimed in claim 5 wherein the shape of the primary transfer means is selected from a block, E-line or T-line transformer (square or oblong section) and split torroidal (round or oval section).

7. An inductive recharger unit as claimed in claim 5 wherein the primary transfer means is a disc of a ferrite powder-polyethylene admixture.

8. An inductive recharger unit as claimed in claim 1, wherein a secondary transfer means is provided.

9. An inductive recharger unit as claimed in claim 8 wherein the secondary transfer means is comprised of the same material as the primary transfer means.

10. An inductive recharger unit as claimed in claim 9 wherein the secondary transfer means comprises a ferromagnetic material arranged to at least partially surround each electromagnetic coil.

11. An inductive recharger unit as claimed in claim 10 wherein the secondary transfer means comprises a complete tube, partial tube or strips of ferromagnetic material arranged circumjacent to the electromagnetic core.

12. An inductive recharger unit as claimed in claim 11 wherein the electromagnetic coils comprise an electrically conductive wire wrapped around a ferromagnetic core.

13. An inductive recharger unit as claimed in claim 12 wherein the primary transfer means comprises a ferromagnetic polymer material.

14. (canceled)

15. (canceled)

16. (canceled)

17. An inductive recharges unit as claimed in claim 13 wherein the primary transfer means is formed by injection moulding.

18. An inductive recharger unit as claimed in claim 13 wherein the primary transfer means is stamped from a sheet of material.

19. An inductive recharges unit as claimed in claim 18 wherein the primary transfer means and/or secondary transfer means is provided with a cover.

20. An inductive recharger unit as claimed in claim 19 wherein the cover comprises a polycarbonate cap.

21. The use of an inductive recharger unit as claimed in claim 19 as a charger unit for a medical device.

22. The use of an inductive recharger unit as claimed in claim 21 wherein the medical device is a syringe driver unit.

23. An inductive recharger unit as claimed in claim 1 further comprising alignment means capable of ascertaining when the electromagnetic coils are in close or touching proximity and when they are aligned with one another.

24. An inductive recharger unit as claimed in claim 23 further comprising control means for controlling the power supply wherein the control means is adapted to switch the power supply on only when the electromagnetic coils are within predetermined proximity and alignment parameters.

25. An inductive recharger unit comprising a master device adapted to transfer electrical power to a slave device comprising; electromagnetic coils associated with the master and slave devices capable of being brought into close or touching proximity of one another; a power supply for delivering electrical currents to the electromagnetic coil of the master device; an alignment means for ascertaining when the electromagnetic coils are in close or touching proximity of and aligned with one other; and a control means for controlling the power supply; wherein the control means is adapted to switch the power supply on only when the electromagnetic coils are within predetermined proximity and alignment parameters.

26. An inductive recharger unit as claimed in claim 25 wherein alignment means comprises a sensor and an indicator, the sensor being capable of sensing when the indicator is in a desired location relative thereto.

27. An inductive recharger unit as claimed in claim 26 wherein the alignment means comprises a light source as an indicator and a light detector as a sensor.

28. An inductive recharger unit as claimed in claim 27 wherein the light source is directional such that the sensor must be aligned therewith to sense the emitted light.

29. An inductive recharger unit as claimed in claim 28 wherein the light source is a shielded light emitting diode and the sensor is a light dependent resistor.

30. An inductive recharger unit as claimed in claim 29 wherein the light source is a focussed infrared light source and the sensor is an infrared detector.

31. An inductive recharger unit as claimed in claim 30 wherein the control means controls the power supply.

32. An inductive recharger unit as claimed in claim 31 wherein the control means comprises a circuit that detects the state of the sensing means,

33. An inductive recharger unit as claimed in claim 32 wherein the control means comprises a circuit that interrogates the sensor to determine whether the light source is in correct alignment therewith.

34. An inductive recharger unit as claimed in claim 33 wherein the sensor provides a light intensity reading that is proportional to the intensity of sensed light, the intensity being a function of the degree of alignment and/or proximity of the light source to the sensor whereby power is delivered to the master device upon sensing of light intensity within a predetermined parameter.

35. An inductive recharger unit as claimed in claim 33 wherein the control means is run using an open or a closed loop mode.

36. An inductive recharger unit as claimed in claim 35 wherein the control means operates in the open loop mode providing no proportional feedback from the battery charge unit allowing for maximum charge current whenever the presence of the slave unit is detected.

37. An inductive recharger unit as claimed in claim 35 wherein the control means is operates in the closed loop mode to generate a non-contact feedback route from the slave to the master for adjustment of the rate of charging to allow a reduction in the rate when the battery is fully charged.

38. An inductive recharger unit as claimed in claim 37 wherein the master device comprises a cradle for retaining the slave device in a desired position.

39. An inductive recharger unit as claimed in claim 38 wherein the cradle is configured to self-align the slave device relative thereto.

40. An inductive recharger unit as claimed in claim 39 wherein the sensing means has communication means associated therewith.

41. An inductive recharger unit as claimed in claim 40 wherein the slave device has a circuit for determining a device parameter and is adopted to make changes to the indicator in response to the desired parameter.

42. An inductive recharger unit as claimed in claim 41 wherein the desired parameter is battery charge status.

43. An inductive recharger unit as claimed in 42 wherein a light source is switched from continuous to flashing mode or vice versa when the battery is fully charged.

44. An inductive recharger unit as claimed in claim 43 wherein the master device is programmed to detect when the slave device is fully charged and to switch off the power supply accordingly.

45. An inductive recharger unit as claimed in claim 44 wherein the unit provides charging means and one or two-way communication means without making any physical electrical connection between the master and slave devices.

46. (canceled)
